(19) United States
(12) Patent Application Publication
(10) Pub. No.: US 2007/0276700 A1
(43) Pub. Date: Nov. 29, 2007

(54) Devices, methods and computer program products for managing contact information in case of emergency

(76) Inventors: Brian Daigle, Marietta, GA (US); Jerry Liu, Atlanta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/439,092

(22) Filed: May 23, 2006

(51) Int. Cl. G06F 19/00

(52) U.S. Cl. 705/3

(57) ABSTRACT

Exemplary embodiments include a method for managing contact information in case of emergency including: receiving from a requesting device a unique identifier corresponding to a emergency subject; retrieving from a database an emergency contact information corresponding to the unique identifier; and communicating the emergency contact information to the requesting device.

### BACKGROUND

The present disclosure relates to the field of managing contact information, and more specifically to managing contact information in case of an emergency (“ICE”).

Many systems are presently available to permit notification to designated persons in the event of an emergency. Fully automated building alarm systems are connected into telephone systems to permit automatic notification to emergency personnel, such as fire, police, or medical personnel, when an alarm is activated. Emergency subject systems commonly interpose a service provider in the system between the alarm and the emergency personnel to add a measure of protection against false alarms reaching the emergency personnel. An additional benefit of emergency subject systems is that persons in addition to the emergency personnel can also be notified.

In conventional emergency subject systems, the emergency subject is presumed to be the calling party and is presumed to be personally able to initiate an emergency call. In situations where the emergency subject is, due to the circumstances of the emergency or other circumstances, unable to place the call, a stranger on the scene would not know the emergency subject's identification number, would not know to place an emergency call through the service provider, and/or would not necessarily have access to the specific telephone that would initiate an automated number identifier system.

There is a need for an emergency alert notification system that permits someone other than a emergency subject to act on behalf of a emergency subject to activate an emergency contact system.

### SUMMARY

Exemplary embodiments include a method for managing contact information in case of emergency including: receiving from a requesting device a unique identifier corresponding to a emergency subject; retrieving from a database an emergency contact information corresponding to the unique identifier; and communicating the emergency contact information to the requesting device.

Exemplary embodiments also include a computer program product for managing contact information in case of emergency, the computer program product including: a storage medium readable by a processing circuit and storing instructions for execution by the processing circuit for facilitating a method including: receiving from a requesting device a unique identifier corresponding to a emergency subject; retrieving from a database an emergency contact information corresponding to the unique identifier; and communicating the emergency contact information to the requesting device.

Exemplary embodiments further include a device for managing contact information in case of emergency including: a communications device for communicating with a emergency subject database containing emergency contact information corresponding to a emergency subject; an input device for receiving a unique identifier from a user, requesting the emergency contact information of the emergency subject; and an output device for providing the emergency contact information of the emergency subject to the user.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several Figures:

FIG. 1 is a flowchart of the operation of a method for managing contact information records in case of emergency in exemplary embodiments;

FIG. 2 is a block diagram of an emergency contact information record in exemplary embodiments;

FIG. 3 is a flowchart of the operation of a method for managing contact information records in case of emergency in other exemplary embodiments;

FIG. 4 is a block diagram of a device for managing contact information in case of emergency in exemplary embodiments;

FIG. 5 is a block diagram of a system for managing contact information in case of emergency in exemplary embodiments;

FIG. 6 is a functional diagram of a system for managing contact information in case of emergency in exemplary embodiments;

FIG. 7 is a screenshot of a login page of emergency subject interface in accordance with exemplary embodiments; and

FIG. 8 is a screenshot of a home page of a emergency subject interface in accordance with exemplary embodiments.

### DETAILED DESCRIPTION

Referring now to the Figures for the purpose of illustrating exemplary embodiments and not for the purpose of limiting the same, it is to be understood that standard components or features that are within the purview of an artisan of ordinary skill and do not contribute to the understanding of the various embodiments of the invention are omitted from the Figures to enhance clarity.

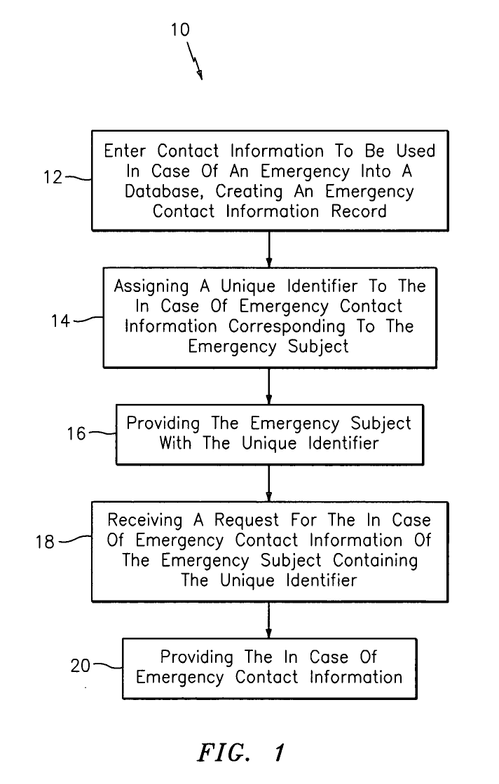

Referring now to FIG. 1, a flow chart of the operation of a method for managing contact information records in case of emergency in exemplary embodiments is generally depicted as 10. Examples of emergencies may include death or bodily injury that may require the assistance of emergency personnel such as military personnel, doctors, police, paramedics, firefighters, and the like. At step 12, an emergency subject emergency subject enters contact information to be used in case of an emergency into a database and creates an emergency contact information record. The database may be maintained by one or more entities, including a hospital (or network of hospitals), insurance providers, military, national security, or law enforcement organizations. The entities or organizations maintaining the database may provide the ICE information via various business arrangements, such as a per-use/access fee, or periodical subscription. The emergency subject may enter contact information into the database using a wide of methods including, but not limited to, a website interface, a voice call with a data entry service, an SMS service, an IM session, or the like. Once the emergency subject has entered in case of emergency contact information and the information has been stored into the database, the emergency subject is then assigned a unique identifier, as shown at step 14. The assigned unique identifier corresponds to the emergency contact information record created at step 12. At step 16, the emergency subject is provided with the unique identifier that corresponds to the emergency contact record created in step 12. The unique identifier may be provided to the emergency subject through a variety of methods including, but not limited to, an email, a SMS service, an IM session, a traditional mail or delivery service (e.g., FedEx™, UPS™, or USPS™), a facsimile transmission, or any combination of the foregoing.

In exemplary embodiments, the emergency subject keeps his or her unique identifier in a conspicuous location, e.g., such that in case of an emergency a third party could easily find the unique identifier and obtain emergency contact information by requesting it from the database, as shown in step 18. For example, the third party could be a police officer or an emergency medical technician, and the emergency subject could have the unique identifier information in his or her wallet, key ring, or cellular phone. In one embodiment, the unique identifier is disposed upon a plastic card similar to a credit card, which clearly indicates the emergency subject's unique identifier as well as instructions for retrieving the emergency subjects in case of emergency contact information. For example, the card may include a phone number that a third party may call to retrieve the in case of emergency contact information for the emergency subject in addition to the emergency subject's unique identifier.

In another exemplary embodiment, the unique identifier can be provided to a third party prior to the occurrence of an emergency situation. For example, the third party may include, but is not limited to, a family member, neighbor, a friend, or coworker whom the emergency subject interacts with on a frequent basis. By providing the third party with the unique identifier prior to an emergency situation the third party can obtain the desired emergency contact information without having to retrieve the unique identifier from the emergency subject, which reduces the time that needed to obtain the emergency contact information. After receiving the request for a emergency subject's emergency contact information in step 18, the emergency contact information is provided to the third party that made the request at step 20. The emergency contact information may be provided to the third party through a variety of methods including, but not limited to, a voice call, an email, a SMS service, an IM session, a FTP session, a TCP/IP data transfer, or the like. Once the third party receives the emergency contact information, the third party is able to contact the emergency contact of the emergency subject. In exemplary embodiments the emergency contact information may also include the emergency subject's contact information, e.g., if the emergency subject wants to be contacted in case of an emergency that affects him/her but of which he/she may not be aware.

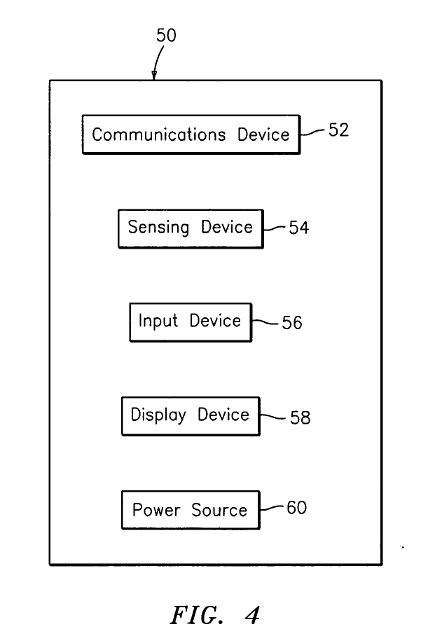

In other exemplary embodiments, the emergency subject may have a radio frequency identification (RFID) tag that contains his or her unique identifier. Other exemplary embodiments may employ the use of a bar code, near field emitter, or any other pattern that can be used to transmit or obtain the unique identifier. Additionally, the third party may be an emergency personnel who is equipped with a device 50 for managing emergency contact information, described in more detail with reference to FIG. 4. The device 50 for managing emergency contact information may include an RFID tag reader that can automatically detect the presence of the RFID tag and obtain the emergency subject's unique identifier. The device 50 may also include a communications device that is capable of automatically contacting the emergency subject database to obtain and display the emergency contact information of the emergency subject. The device may also be programmed such that a password, PIN, or USERID can be entered so that only an authorized emergency personnel has the ability to obtain such ICE information. The third party is then able to contact the emergency contact of the emergency subject once the device 50 receives and displays the emergency subject's emergency contact information. The device may also be programmed with software that is able to communicate a emergency subject's ICE information to another software program module (or synchronize with another module) for storage in another database, such as a hospital records database. This would allow the information initially obtained by the attending emergency personnel operating device 50 to be propagated throughout the chain of treatment or attendance.

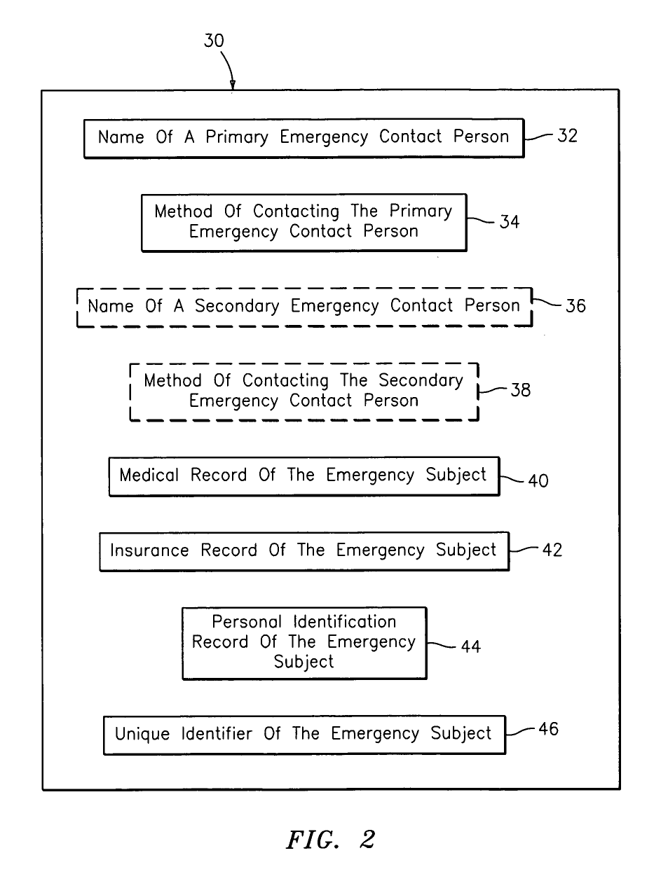

Turning now to FIG. 2, a block diagram of an emergency contact information record in exemplary embodiments is generally depicted as 30. The emergency contact information record 30 includes at least one of the following: a name of a primary emergency contact person 32; a method of contacting the primary emergency contact person 34; a medical record of the emergency subject 40; an insurance record of the emergency subject 42; a personal identification record of the emergency subject 44, and a unique identifier of the emergency subject 46. Additionally, the emergency contact information record 30 may include a name of a secondary emergency contact person 36 and a method of contacting the secondary emergency contact person 38. In exemplary embodiments, the unique identifier of the emergency subject 46 is the primary key used by the emergency subject database and each emergency contact information record is associated with one unique identifier.

The method of contacting the primary emergency contact person 34 may include providing, for example, at least one of: a home phone number of the primary emergency contact person; a cell phone number of the primary emergency contact person; a work phone number of the primary emergency contact person; an email address of the primary emergency contact person; and an instant messaging address of the primary emergency contact person. Likewise, the method of contacting a secondary emergency contact person 38 may include providing, for example, at least one of: a home phone number of the secondary emergency contact person; a cell phone number of the secondary emergency contact person; a work phone number of the secondary emergency contact person; an email address of the secondary emergency contact person; and an instant messaging address of the secondary emergency contact person. Additionally, the personal identification record of the emergency subject 44 may include, for example, at least one of a photo of the emergency subject, a physical description of the emergency subject, and a fingerprint of the emergency subject. Furthermore, the medical record of the emergency subject 40 may include, for example, at least one of a blood type of the emergency subject, an allergy of the emergency subject, a disability of the emergency subject, and a medical history of the emergency subject.

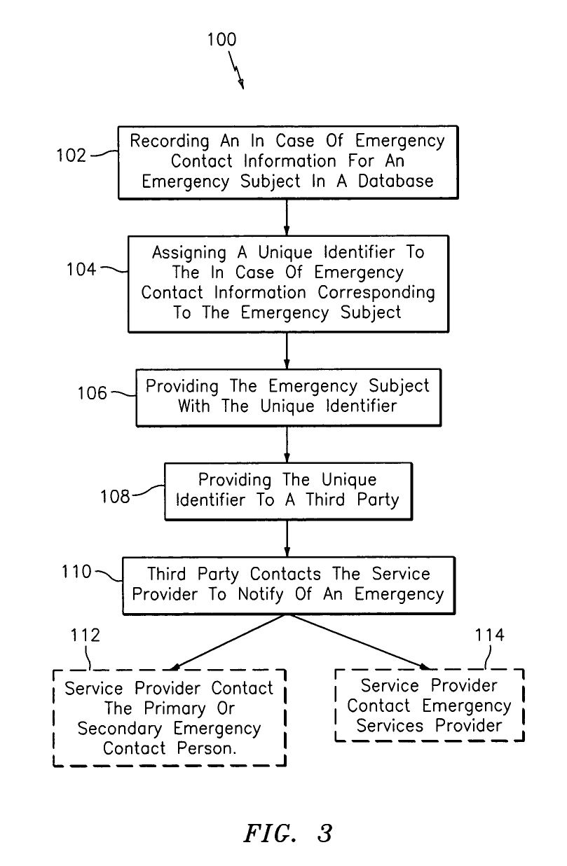

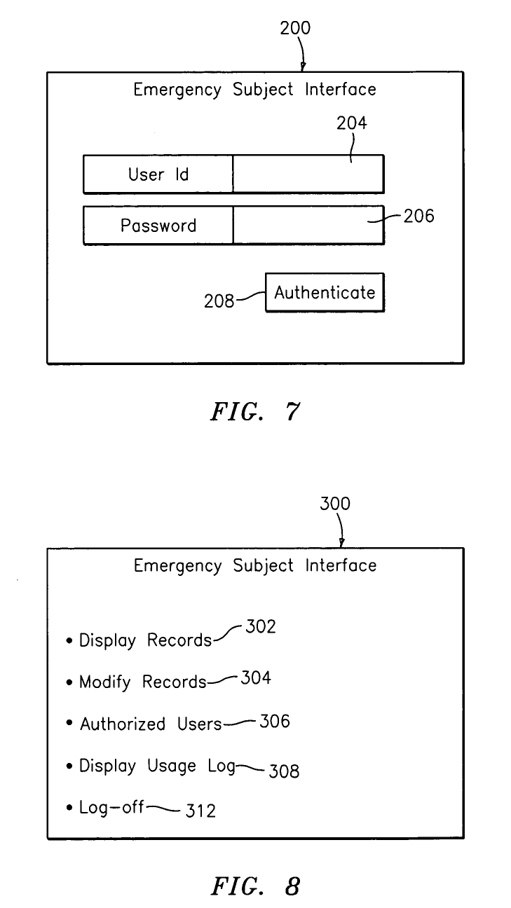

Referring now to FIG. 3, a flow chart of the operation of a method for managing contact information records in case of emergency in other exemplary embodiments is generally depicted as 100. At step 102, a emergency subject enters emergency contact information into a database and creates an emergency contact information record. In one embodiment, the emergency subject may create or modify their emergency contact information record through a web-interface discussed in further detail herein with reference to FIG. 7. The emergency subject is then assigned a unique identifier, shown at step 104, which corresponds to the emergency contact information record created at step 102. At step 106, the emergency subject is provided with the unique identifier that corresponds to the emergency contact record created in step 102. A third party is provided with the unique identifier, as shown at step 108. As described above, the third party may be provided with the unique identifier prior to the emergency situation or the third party may retrieve the unique identifier from the emergency subject at the time of the emergency.

Continuing with FIG. 3 as shown at step 110, once the third party obtains the unique identifier the third party may contact a service provider, which maintains the database of emergency contact information records. The third party may contact the service provider using through a variety of methods including, but not limited to, a voice call, an SMS message, a IM chat, or the like. In exemplary embodiments, the third party may provide information about the emergency situation to the service provider including, but not limited to, a nature of the emergency, a location of the emergency, and/or a condition of the emergency subject. At this point, the service provider may contact the primary emergency contact person or the secondary emergency contact person to notify them of the emergency situation, as shown at step 112. Additionally as shown at step 114, the service provider may contact an emergency service, such as an ambulance, a fire station, or a police officer depending upon the nature of the emergency.

Turning now to FIG. 4, a device for managing emergency contact information that may be used by emergency personnel including, but not limited to, policemen, firemen, and/or emergency personnel is generally depicted as 50. In an exemplary embodiment, the device 50 for managing emergency contact information includes a communications device 52 for communicating with a emergency subject database; a sensing device 54 for sensing the unique identifier of a emergency subject; an input device 56 for receiving input from a user; and a display device 58 for displaying the emergency contact information of the emergency subject. In addition to a custom device having such exemplary features, various devices may also be configured to submit such information, including a computer, a portable computing device, or a wireless communications device (such as a laptop, handheld computing device, or cellular phone). In exemplary embodiments, emergency personnel may use the device 50 for retrieving the unique identifier from an emergency subject and for retrieving the emergency subject's emergency contact information from the emergency subject database maintained by the service provider.

Continuing with reference to FIG. 4, the communications device 52 allows the device 50 to communicate with the emergency subject database either directly or through a communications network such as the Internet. The communications device 52 may include, but is not limited to, a cellular phone, a Wifi device, a Bluetooth™ device, or the like. The sensing device 54 allows the device 50 to sense the presence of a unique identifier of a emergency subject and may include, but is not limited to, an RFID tag reader, a Bluetooth™ device, an IR device, or the like. The input device 56 allows the user to input information into the device 50 and may include, but is not limited to, a keyboard, a stylus, a microphone and voice recognition software, or the like. The display device 58 allows the user to retrieve information from the device 50 and may include, but is not limited to, an electroluminescent display, an LED display, a CRT display device, a LCD device, a speaker, or the like.

In exemplary embodiments, a emergency subject is assigned a unique identifier. The unique identifier may be stored on an RFID tag (or barcode, near field transmitter, magnetic strip, etc.) that permits the unique identifier to be electronically conveyed to the device 50. In the event that the unique identifier is not electronically conveyed to the device 50, the emergency personnel may use the input device 56 to manually enter the unique identifier. After the device 50 receives the unique identifier, it uses the communications device 52 to obtain the emergency contact information of the emergency subject from the emergency subject database. The communication between the device 50 and the emergency subject database may include, but is not limited to, an IP data transfer, a instant message session, an SMS exchange, a voice call, or the like. Once the emergency contact information is received, the device 50 may use the display device 58 to communicate the emergency contact information to the emergency personnel. Optionally, the device 50 may also include a power source 60, such as a battery, which allows the device 50 to be used without requiring a physical connection to a power supply.

In an exemplary embodiment, the device 50 may be designed to automatically contact the emergency subject's emergency contacts once it receives their emergency contact information. The device 50 may contain several preprogrammed emergency alert notifications and based on the type of emergency the device 50 may provide such emergency alerts to the emergency contacts. For example, the emergency subject may have suffered a heart attack and been taken to the hospital, the device 50 can automatically contact the emergency contacts and provide them with that information. The device 50 can use various methods to automatically contact the emergency contacts including, but not limited to, an instant messaging session, an SMS exchange, a voice call, e-mail, or any other type of messaging system.

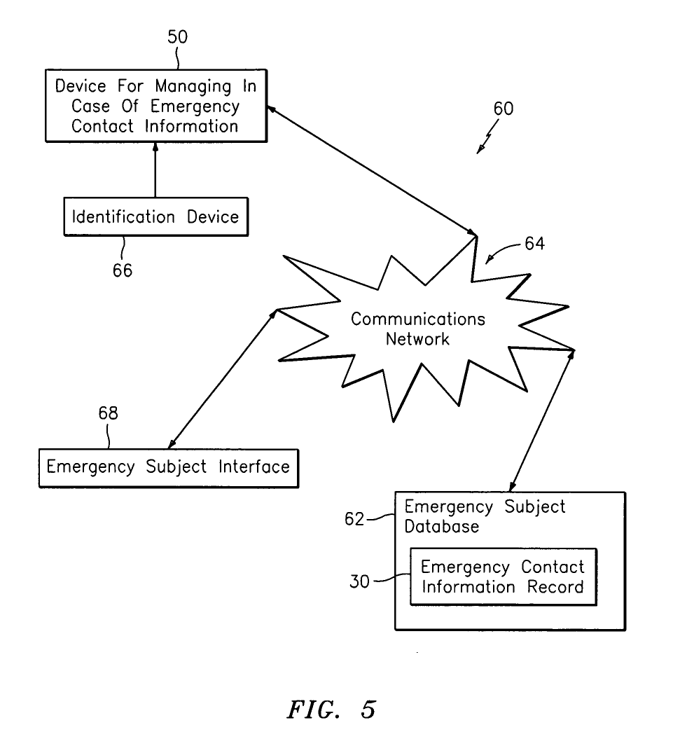

Turning now to FIG. 5, a block diagram of a system for managing emergency contact information in exemplary embodiments is depicted generally as 60. According to an exemplary embodiment, the system for managing emergency contact information includes the device 50 for managing emergency contact information, a emergency subject database 62, a communications network 64, an identification device 66, and a emergency subject interface 68. The emergency subject database 62 contains the emergency contact information record 30 for each emergency subject and may be implemented using any suitable database software and design including, but not limited to, Apple™ FileMaker™, Microsof™ Access™, Oracle™ 9i, SQL, or the like. The communications network 64 may include, but is not limited to, the Internet, a telephone network, a wireless network, an intranet, or any combination of the foregoing.

Continuing with reference to FIG. 5, the identification device 66 contains the unique identifier of the emergency subject and be, but is not limited to, a cellular phone, a PDA, an RFID tag, a business card, a distinctive pattern or bar code on driver's license, a cellular telephone, or any other items or capable of containing or transmitting a unique identifier. The emergency subject interface 68 allows a emergency subject to create and/or update his or her emergency contact information record 30 in various ways including, but not limited to, a website interface, an automated phone system, by mail, or by email. Such a device, for example the cellular phone, may be programmed to prompt the user for their ICE information prior to allowing the user to use the device. Additionally, in other exemplary embodiments other individuals that have been authorized by the emergency subject, including doctors, family members, or government agents may be given permission to change the emergency contact information 30 via the emergency subject interface 68 on behalf of the emergency subject.

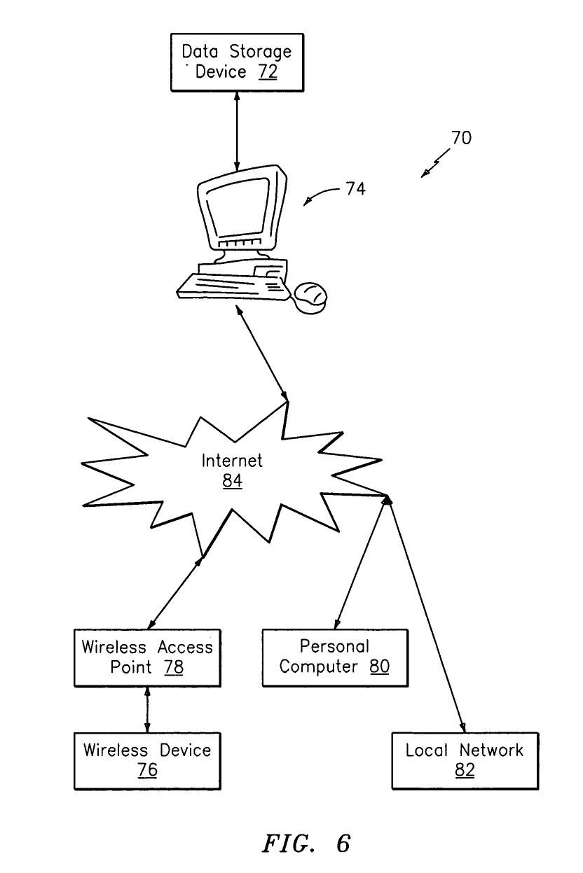

Continuing now with reference to FIG. 6, a functional diagram of a system for managing emergency contact information in exemplary embodiments is depicted generally as 70. As illustrated, a plurality of users may connect to a server 74 through a communications network such as Internet 84. The users may access the Internet 84 though a variety of client devices including, but not limited to, a wireless device 76 and a wireless access point 78, a local network 82, or a personal computer 80. The emergency subject database 62 may be located on a data storage device 72 or may be distributed across multiple data storages devices for redundancy purposes. The data storage device(s) 72 are in operative communication with a server 74. In exemplary embodiments, the server 74 may provide the emergency subject interface 68. It will be appreciated by those of ordinary skill in the art that the client device and connections illustrated in FIG. 6 are shown by the way of example and this disclosure is not limited to the examples depicted. Furthermore, the disclosure may be applicable to any client device, connection, and external network that can be use to support managing emergency contact information.

In an exemplary embodiment, the server 74 may be used to authenticate the device 50 before establishing a communications session between the emergency subject database 62 the device 50. For example, the service provider that maintains the emergency subject database may wish to control access by devices 50 to the emergency subject database to known or trusted devices. The server 74 may authenticate the device 50 through any number of authentication techniques including, but not limited to technologies related to a USERID and password. Generally speaking, the authentication process includes the server receiving data, such as a USERID and a password, and comparing that data with data stored on data storage device 72. If the data submitted by the device 50 matches the data stored in the data storage device 72, the device 50 can be authenticated, and is granted access to the emergency subject database 62.

Turning now to FIG. 7, an exemplary screen shot of a login page of the emergency subject interface 68 is generally depicted as 200. The login page 200 includes an authentication function that requires the emergency subject to provider their unique identifier in an input field 204 and a password in an input field 206. After providing their unique identifier and password the emergency subject submits the information for authentication by clicking on an authenticate button 208. If the emergency subject has entered a valid unique identifier and password the emergency subject is redirected to a emergency subject home page 300, discussed herein in further detail with reference to FIG. 8. Otherwise, the emergency subject is again directed to the login page 200 and prompted to re-enter their unique identifier and password.

Referring now to FIG. 8, an exemplary screen shot of a home page of the emergency subject interface 68 is generally depicted as 300. The home page 300 includes a display record function 302 which displays the emergency subject's emergency contact information record 30 including: a name of a primary emergency contact person 32; a method of contacting the primary emergency contact person 34; a medical record of the emergency subject 40; an insurance record of the emergency subject 42; a personal identification record of the emergency subject 44, a unique identifier of the emergency subject 46, a name of a secondary emergency contact person 36, and a method of contacting the secondary emergency contact person 38. The home page 300 includes a modify record function 304 which allows the emergency subject to modify the emergency subject's emergency contact information record 30 including: a name of a primary emergency contact person 32; a method of contacting the primary emergency contact person 34; a medical record of the emergency subject 40; an insurance record of the emergency subject 42; a personal identification record of the emergency subject 44, a unique identifier of the emergency subject 46, a name of a secondary emergency contact person 36, and a method of contacting the secondary emergency contact person 38.

Continuing with reference to FIG. 8, the home page 300 may include an authorized user function 306, which allows the emergency subject to add and/or remove third parties access to his or her emergency contact information record 30. The home page 300 may also include a display log function 308, which allows the emergency subject to view a log of third party requests for his or her emergency contact information record 30 as well as a log of use for the emergency subject interface 68. Additionally, the home page 300 may include a log-out function 312 that allows the user to end their secure session with the emergency subject database. Once the user executes the log-off function 312 the user interface returns to the login page 200, as depicted in FIG. 7.

As described above, embodiments may be in the form of computer-implemented processes and apparatuses for practicing those processes. In exemplary embodiments, the invention is embodied in computer program code executed by one or more processors. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for managing contact information in case of emergency comprising:
receiving from a requesting device a unique identifier corresponding to a emergency subject;
retrieving from a database an emergency contact information corresponding to the unique identifier; and
communicating the emergency contact information to the requesting device.

2. The method of claim 1, wherein the emergency contact information record comprises at least one of the following:
a name of a primary emergency contact person;
a method of contacting the primary emergency contact person;
a medical record of the emergency subject;
an insurance record of the emergency subject; and
a personal identification record of the emergency subject.

3. The method of claim 2, wherein the method of contacting the primary emergency contact person comprises at least one of the following:
a home phone number of the primary emergency contact person;
a cell phone number of the primary emergency contact person;
a work phone number of the primary emergency contact person an email address of the primary emergency contact person; and
an instant messaging address of the primary emergency contact person.

4. The method of claim 2, wherein the personal identification record of the emergency subject comprises at least one of the following:
a photo of the emergency subject;
a physical description of the emergency subject; and
a fingerprint of the emergency subject.

5. The method of claim 2, wherein the medical record of the emergency subject comprises at least one of the following:
a blood type of the emergency subject;
an allergy of the emergency subject;
a disability of the emergency subject; and
a medical history of the emergency subject.

6. The method of claim 2, wherein the emergency contact information record comprises at least one of the following:
a name of a secondary emergency contact person; and
a method of contacting the secondary emergency contact person.

7. The method of claim 6, wherein the method of contacting the secondary emergency contact person comprises at least one of the following:
a name of a secondary emergency contact person;
a cell phone number of the secondary emergency contact person;
a work phone number of the secondary emergency contact person
an email address of the secondary emergency contact person; and
an instant messaging address of the secondary emergency contact person.

8. The method of claim 1, wherein the third party is an emergency personnel.

9. The method of claim 2, further comprising notifying the primary emergency contact person that the emergency subject is in an emergency situation.

10. A computer program product for managing contact information in case of emergency, the computer program product comprising:
a storage medium readable by a processing circuit and storing instructions for execution by the processing circuit for facilitating a method comprising:
receiving from a requesting device a unique identifier corresponding to a emergency subject;
retrieving from a database an emergency contact information corresponding to the unique identifier; and
communicating the emergency contact information to the requesting device.

11. The computer program product of claim 10, wherein the emergency contact information record comprises at least one of the following:
a name of a primary emergency contact person;
a method of contacting the primary emergency contact person;
a medical record of the emergency subject;
an insurance record of the emergency subject; and
a personal identification record of the emergency subject.

12. The computer program product of claim 10, wherein the emergency contact information record comprises at least one of the following:
a name of a secondary emergency contact person; and
a method of contacting the secondary emergency contact person.

13. The computer program product of claim 11, the method of contacting the primary emergency contact person comprises at least one of the following:
a home phone number of the primary emergency contact person;
a cell phone number of the primary emergency contact person;
a work phone number of the primary emergency contact person an email address of the primary emergency contact person; and
an instant messaging address of the primary emergency contact person.

14. The computer program product of claim 11, wherein the method of contacting the secondary emergency contact person comprises at least one of the following:
a name of a secondary emergency contact person;
a cell phone number of the secondary emergency contact person;
a work phone number of the secondary emergency contact person an email address of the secondary emergency contact person; and
an instant messaging address of the secondary emergency contact person.

15. The computer program product of claim 10, wherein the medical record of the emergency subject comprises at least one of the following:
a blood type of the emergency subject;
a allergy of the emergency subject;
a disability of the emergency subject; and
a medical history of the emergency subject.

16. The computer program product of claim 10, wherein the third party is an emergency personnel.

17. The computer program product of claim 11, further comprising notifying the primary emergency contact person that the emergency subject is in an emergency situation.

18. A device for managing contact information in case of emergency comprising:
a communications device for communicating with a emergency subject database containing emergency contact information corresponding to a emergency subject;
an input device for receiving a unique identifier from a user, requesting the emergency contact information of the emergency subject; and
an output device for providing the emergency contact information of the emergency subject to the user.

19. The device of claim 18, further comprising a sensing device for sensing the unique identifier of the emergency subject, wherein the unique identifier is a primary key for the emergency subject database.

20. The device of claim 19, wherein the sensing device is a radio frequency identification reader and the unique identifier of the emergency subject is stored on a radio frequency identification tag.
